(19) United States
(12) Patent Application Publication
(10) Pub. No.: US 2013/0169249 A1
(43) Pub. Date: Jul. 4, 2013

(54) MULTI-PHASE DC-DC CONVERTER AND METHOD OF CONTROLLING THE SAME

(71) Applicants: Li-Min Lee, New Taipei City (TW); Quan Gan, Wuxi (CN); Chung-Che Yu, New Taipei City (TW); Shian-Sung Shiu, New Taipei City (TW)

(72) Inventors: Li-Min Lee, New Taipei City (TW); Quan Gan, Wuxi (CN); Chung-Che Yu, New Taipei City (TW); Shian-Sung Shiu, New Taipei City (TW)

(73) Assignee: GREEN SOLUTION TECHNOLOGY CO., LTD., New Taipei City (TW)

(21) Appl. No.: 13/449,321

(22) Filed: Apr. 18, 2012

(30) Foreign Application Priority Data
Dec. 29, 2011 (TW) 100149372

(51) Int. Cl. G05F 1/00

(52) U.S. Cl. 323/272

(57) ABSTRACT

A multi-phase DC-DC converter and a method of controlling a multi-phase DC-DC converter are disclosed. The multi-phase DC-DC converter is adapted to control a plurality of channels in a multi-phase DC-DC converting circuit for providing an output voltage. The multi-phase DC-DC converter comprises a constant on unit, a plurality of PWM units and a pulse width logic unit. The constant on unit determines a time point of generating a turning on signal indicative of a preset time period according to the output voltage. Each PWM unit generates a PWM signal, and a pulse width thereof is determined according to the turning on signal and currents of the channels. The pulse width logic unit controls the channels according to the corresponding PWM signals generated by the plurality of PWM units.

### CROSS-REFERENCE TO RELATED APPLICATION

This application claims the priority benefit of Taiwan application serial no. 100149372, filed on Dec. 29, 2011. The entirety of the above-mentioned patent application is hereby incorporated by reference herein and made a part of this specification.

### BACKGROUND

1. Field of the Invention

The present invention relates to a DC-DC converter and a method of controlling the same, and more particularly a multi-phase DC-DC converter and a method of controlling the same.

2. Description of Related Art

The size of the integrated circuit is much smaller by the evolution of the technique of the manufacturing process. A voltage level of the driving voltage may be decreased with the miniaturization of the integrated circuit. However, a reduction in the power consumption of the integrated circuit in some field may not be in proportion to a reduction in the voltage level of the driving voltage. That results in that an operating current of the integrated circuit increases in reverse.

The driving voltage for the integrated circuit is mainly provided by a switching power supply. However, the switching operation of the switching power supply causes an output voltage of the switching power supply having a voltage ripple. The voltage ripple is much obviously in a system with low driving voltage, even induces logic error in the integrated circuit. For decreasing the voltage ripple of the switching voltage source circuit, a multi-phase DC-DC converter is developed. The multi-phase DC-DC converter has several channel to share current transmitted from an input power and so reduces the transmitted power by the channels in every time as well as the voltage ripple.

FIG. 1 is a schematic diagram of a conventional multi-phase DC-DC converting circuit. The multi-phase DC-DC converter comprises a controller 10, and three channels 12a, 12b and 12c, wherein each channel 12a, 12b and 12c comprises two transistor switches connected in series between an input voltage Vin and a ground. Each channel 12a, 12b and 12c has a driver which respectively receives PWM control signals PWM1, PWM2 and PWM3 from the controller 10 and switches the corresponding transistor switch for providing channel currents Io1, Io2 and Io3. An output capacitance C is charged by an output current to which is a sum of the channel currents Io1, Io2 and Io3 to generate an output voltage Vout to drive a load LD. The controller 10 detects the channel currents Io1, Io2 and Io3 through pins CSP1 and CSN1, CSP2 and CSN2, and CSP3 and CSN3 and receives a voltage feedback signal FB to modulate duty cycles of the transistor switches in the channels 12a, 12b and 12c.

The controller 10 adjusts the amount of the channel currents Io1, Io2 and Io3 according to the detecting signals of the pins CSP1 and CSN1, CSP2 and CSN2, and CSP3 and CSN3 to balance the channel currents Io1, Io2 and Io3 for reducing current ripples caused by the channels 12a, 12b and 12c. Generally, the controller 10 executes feedback control by an error amplifier first to get a reference of the duty cycles of the channels 12a, 12b and 12c. Then, the controller 10 compensates the duty cycles according to current differences of the channel currents Io1, Io2 and Io3. The error amplifier has an advantage of suppressing noise but slow transient response, and so cannot process fast loading variation. The compensation for balancing channel currents Io1, Io2 and Io3 is first to sum up the channel currents Io1, Io2 and Io3, then to calculate a current average and finally to adjust the duty cycles of the channels based on the current differences. The computing of the current differences is more complex, and it may cause the design of the multi-phase DC-DC converter being hard.

### SUMMARY

The conventional multi-phase DC-DC converter has slow transient response and complex circuit design. A multi-phase DC-DC converter of the present invention utilizes a constant on-time control scheme to provide fast transient response. Moreover, the multi-phase DC-DC converter of the present invention balances the channel currents by compensating pulse width, without the computing of sum and average to reducing design complexity.

To accomplish the aforementioned and other objects, an exemplary embodiment of the invention provides a multi-phase DC-DC converter. The multi-phase DC-DC converter is adapted to control a plurality of channels in a multi-phase DC-DC converting circuit for providing an output voltage. The multi-phase DC-DC converter comprises a constant on unit, a plurality of PWM units and a pulse width logic unit. The constant on unit determines a time point of generating a turning on signal indicative of a preset time period according to the output voltage. Each PWM unit generates a PWM signal, and a pulse width thereof is determined according to the turning signal and currents of the channels. The pulse width logic unit controls the channels according to the corresponding PWM signals generated by the plurality of PWM units.

An exemplary embodiment of the invention also provides a method of controlling a multi-phase DC-DC converter. The multi-phase DC-DC converter is adapted to balance currents of a plurality of channels in a multi-phase DC-DC converting circuit. The controlling method includes the steps of: setting a constant on time period; detecting the currents of the plurality of channels to generate a plurality of current detecting signals; determining current differences between one channel and other channels; and generating a PWM signal to control the corresponding channel, wherein a pulse width of the PWM signal is determined according the constant on time period and the current differences.

It is to be understood that both the foregoing general description and the following detailed description are exemplary, and are intended to provide further explanation of the invention as claimed. In order to make the features and the advantages of the invention comprehensible, exemplary embodiments accompanied with figures are described in detail below.

### BRIEF DESCRIPTION OF THE DRAWINGS

The present invention will now be specified with reference to its preferred embodiment illustrated in the drawings, in which:

FIG. 1 is a schematic diagram of a conventional multi-phase DC-DC converting circuit;

FIG. 2 is a block diagram of a multi-phase DC-DC converter of the present invention;

FIG. 3 is a schematic diagram of a multi-phase DC-DC converter according to a first embodiment of the present embodiment;

FIG. 4 is a schematic diagram of the PWM unit shown in FIG. 3;

FIG. 5 is a schematic diagram of a multi-phase DC-DC converter according to a second embodiment of the present embodiment; and

FIG. 6 is a schematic diagram of the PWM unit shown in FIG. 5.

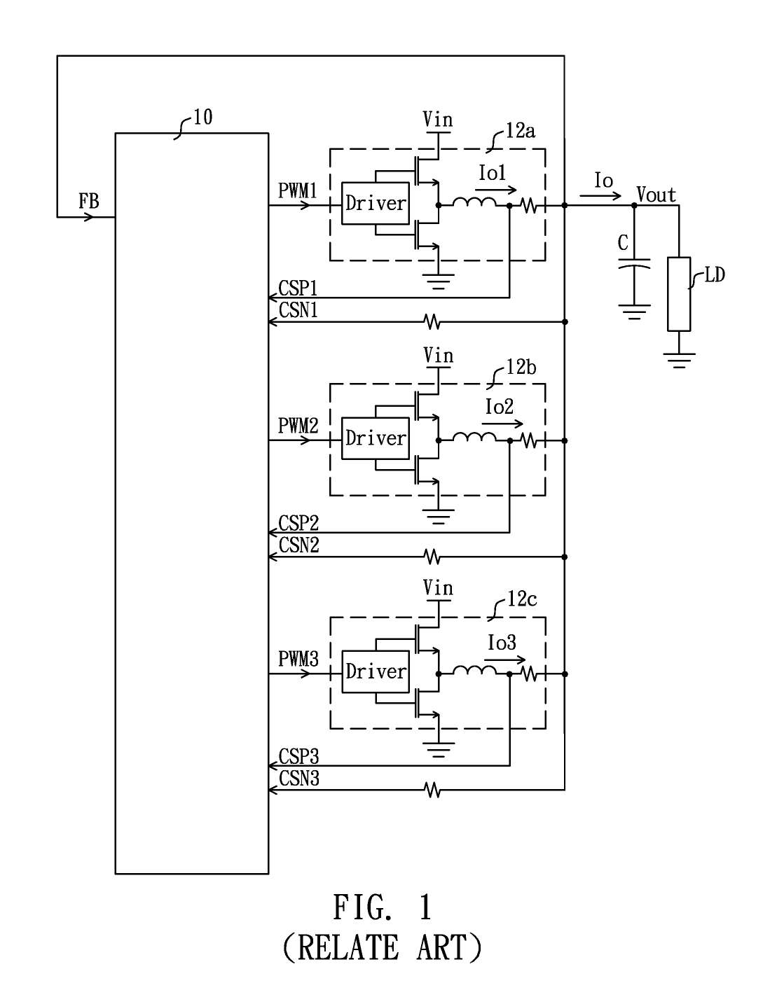

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

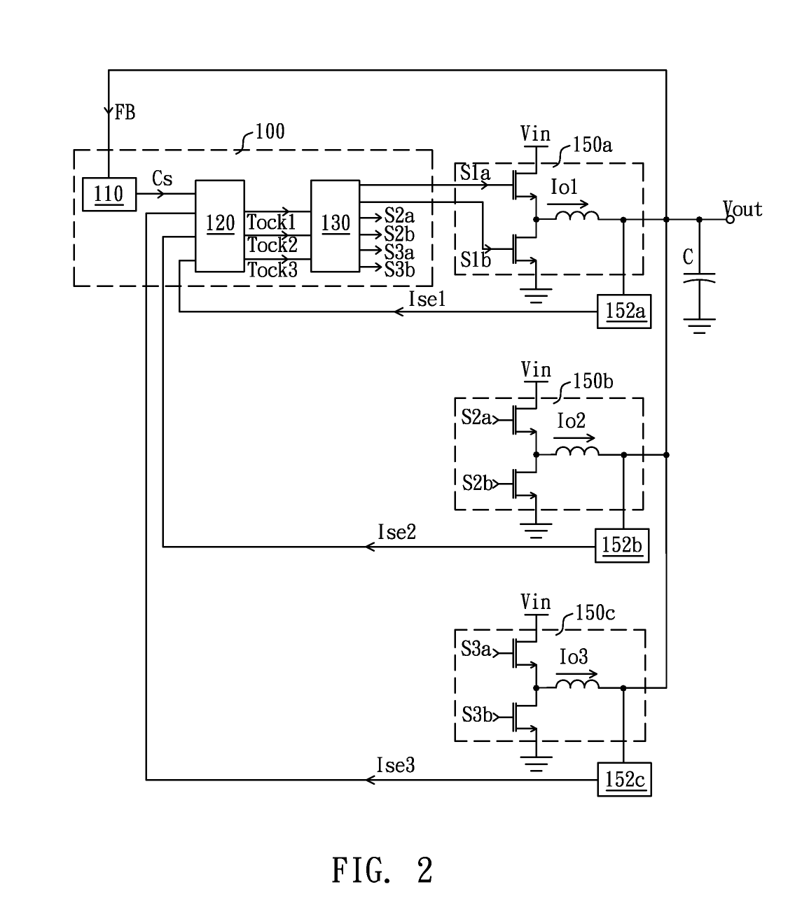

FIG. 2 is a block diagram of a multi-phase DC-DC converter of the present invention. The multi-phase DC-DC converter is adapted to control a multi-phase DC-DC converting circuit. The multi-phase DC-DC converting circuit comprises channels 150a, 150b and 150c which are coupled to an input voltage Vin. The channels 150a, 150b and 150c respectively provide channel currents Io1, Io2 and Io3 according to PWM control signals S1a, S1b, S2a, S2b, S3a and S3b generated by a multi-phase DC-DC converter 100 to charge an output capacitance C to provide an output voltage Vout. The multi-phase DC-DC converter 100 comprises a constant on unit 110, a PWM module 120 and a pulse width logic unit 130. The constant on unit 110 receives a voltage feedback signal FB indicative of the output voltage Vout and accordingly determines a time point of generating a turning on signal Cs, wherein the turning on signal Cs is used to indicate a constant time period. The PWM module 120 comprises a plurality of PWM units (not shown) to generate a plurality of PWM signals Tock1, Tock2 and Tock3 to control the multi-phase DC-DC converting circuit. Current detecting circuits 152a, 152b and 152c are respectively coupled to the channels 150a, 150b and 150c to detect the channel currents Io1, Io2 and Io3 and generate current detecting signals Ise1, Ise2 and Ise3 indicative of the amount of the channel currents. The PWM signals Tock1, Tock2 and Tock3 generated by each PWM unit controls corresponding channels in the multi-phase DC-DC converting circuit. Pulse widths of the PWM signals Tock1, Tock2 and Tock3 are determined according to the current detecting signals Ise1, Ise2, Ise3 and the turning on signal Cs generated by the constant on unit 110. The pulse width logic unit 130 generates PWM control signals S1a, S1b, S2a, S2b, S3a and S3b to control the corresponding channels 150a, 150b and 150c according to the PWM signals Tock1, Tock2 and Tock3 generated by the plurality of PWM units.

The PWM module 120 computes current differences among the channel currents Io1, Io2 and Io3 and adjusts the turning on signal Cs, i.e., the constant on time period, according to the current differences. The duty cycles of the PWM control signals S1a, S1b, S2a, S2b, S3a and S3b generated by the pulse width logic unit 130 are adjusted, thereby reducing the current differences. The following embodiments will describe the present invention detailedly.

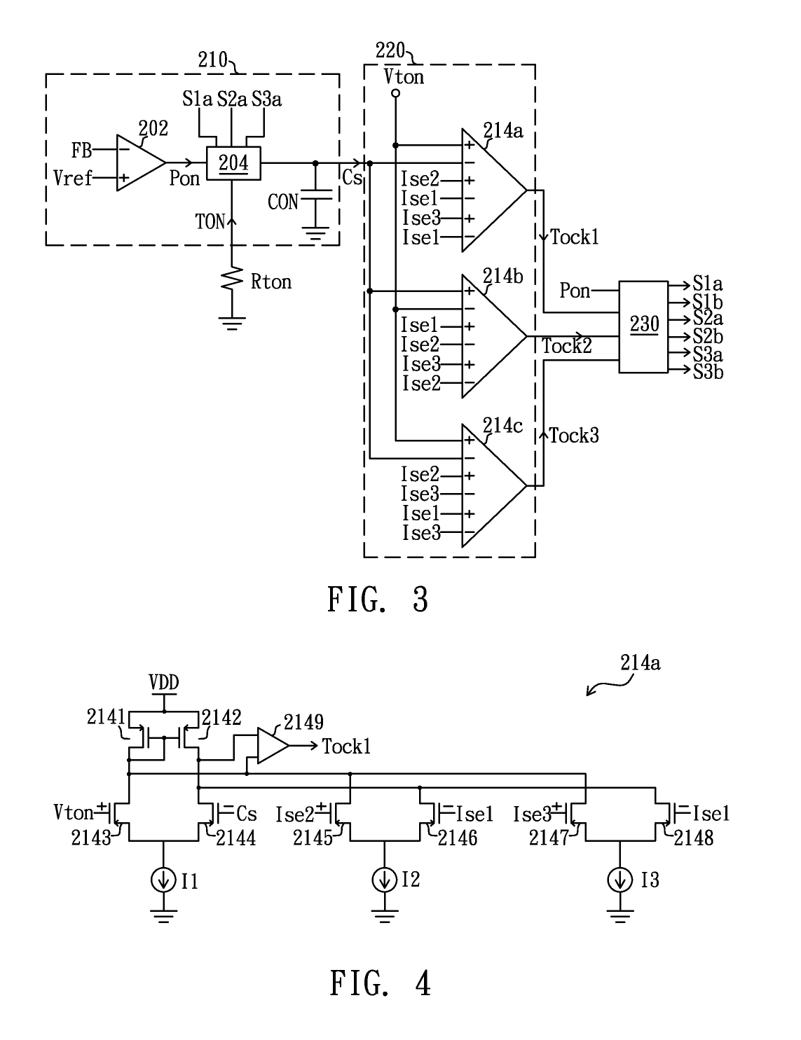

FIG. 3 is a schematic diagram of a multi-phase DC-DC converter according to a first embodiment of the present embodiment. The multi-phase DC-DC converter comprises a constant on unit 210, a PWM module 220 and a pulse width logic unit 230. The constant on unit 210 comprises a comparator 202, a turning on controller 204 and a time capacitor CON. A non-inverting input terminal of the comparator 202 receives a reference voltage Vref and an inverting input terminal thereof receives a voltage feedback signal FB. When a voltage level of the voltage feedback signal FB is lower than that of the reference voltage Vref, an output signal Pon of the comparator 202 is generated to the turning on controller 204. The turning on controller 204 starts to charge the time capacitor CON with a set current to generate a turning on signal Cs when receiving the output signal Pon of the comparator 202. The set current may be determined by a time set resistance Rton connected externally. Therefore, users can set the constant on time period of the multi-phase DC-DC converter according to the actual application.

The PWM module 220 comprises PWM units 214a, 214b and 214c and receives the turning on signal Cs. The PWM units 214a, 214b and 214c judge current differences between the corresponding channel and other channels according to current detecting signals Ise1, Ise2 and Ise3 to respectively generate the PWM signals Tock1, Tock2 and Tock3. Therefore, the pulse widths of the PWM signals Tock1, Tock2 and Tock3 are adjusted based on the current differences between the corresponding channel and other channels. The pulse width logic unit 230 is coupled to the PWM module 220 and generates PWM control signals S1a, S1b, S2a, S2b, S3a and S3b according to the PWM signals Tock1, Tock2 and Tock3. The turning on controller 204 in the constant on unit 210 receives the PWM control signals S1a, S2a and S3a and accordingly discharges the time capacitor CON for resetting the voltage level of the turning on signal Cs to zero. The pulse width logic unit 230 receives the output signal Pon of the comparator 202 to count the times of the output signal Pon. Accordingly, the pulse width logic unit 230 determines which group of PWM control signals S1a and S1b, S2a and S2b, and S3a and S3b being generated at this time to turn on the corresponding channel. Therefore, by the method mentioned above, the present invention controls the plurality of channels of the multi-phase DC-DC converter with time division.

FIG. 4 is a schematic diagram of the PWM unit shown in FIG. 3. Due to that the circuit structures of the PWM units 214a, 214b and 214c are the same, the PWM unit 214a is described for example here. The PWM unit 214a is a multi-input amplifier and comprises a current mirror, a plurality of differential pairs and a gain circuit 2149. The current mirror is coupled to a driving voltage source VDD and comprises P-type MOSFETs 2141 and 2142, wherein the gates of the P-type MOSFET 2141 and 2142 are mutually connected. A first differential pair comprises a current source I1 and N-type MOSFETs 2143 and 2144. The N-type MOSFETs 2143 and 2144 are respectively connected to the P-type MOSFETs 2141 and 2142 in the current mirror. A gate of the N-type MOSFET 2143 receives a reference voltage Vton and a gate of the N-type MOSFET 2144 receives the turning on signal Cs. Thereby, the first differential pair compares the reference voltage Vton with the turning on signal Cs. A second differential pair comprises a current source 12 and N-type MOSFETs 2145, 2146. The N-type MOSFETs 2145 and 2146 are respectively coupled to the P-type MOSFETs 2141 and 2142 in the current mirror. A gate of N-type MOSFET 2145 receives the current detecting signal Ise2 and a gate of N-type MOSFET 2146 receives the current detecting signal Ise1. Thereby, the second differential pair judges the current difference between two channels. A third differential pair comprises a current source 13 and N-type MOSFET 2147 and 2148. The N-type MOSFETs 2147, 2148 are respectively coupled to the P-type MOSFETs 2141, 2142 in the current mirror. A gate of the N-type MOSFET 2147 receives the current detecting signal Ise3 and a gate of the N-type MOSFET 2148 receives the current detecting signal Ise1. Thereby, the third differential pair judges the current difference between two channels.

The gain circuit 2149 generates the PWM signal Tock1 according to voltage levels of the drains of the P-type MOSFETs 2141, 2142 in the current mirror. If there are no the second and third differential pairs, the voltage level of the drain of the P-type MOSFET 2142 is lower than that of the drain of the P-type MOSFET 2141 when the voltage level of the turning on signal Cs is higher than the voltage level of the reference voltage Vton. At this time, the gain circuit 2149 stops generating the PWM signal Tock1, and so the corresponding channel is cut off. If there are the second and third differential pairs, the PWM signal Tock1 is modulated according to the current differences. The explanation is as follows.

When the current detecting signal Ise2(Ise3) is higher than the current detecting signal Ise1, a current flowing through the N-type MOSFET 2145 (2147) is higher than a current flowing through the N-type MOSFET 2146 (2148) to provide a positive compensation. The gain circuit 2149 stops generating the PWM signal Tock1 when the current flowing through the N-type MOSFET 2144 is higher than the current flowing through the N-type MOSFET 2143 a sum of the compensations of the second and third differential pairs. At this time, the voltage level of the turning on signal Cs is higher than that has no the second and third differential pairs. Therefore, the current of the channel is increased due to the extension of the turning on period of the channel. On the other hand, when the current detecting signal Ise2 (Ise3) is lower than the current detecting signal Ise1, the current flowing through the N-type MOSFET 2145 (2147) is lower than the current flowing through the N-type MOSFET 2146 (2148) to provide a negative compensation. The gain circuit 2149 stops generating the PWM signal Tock1 when the current flowing through the N-type MOSFET 2143 is lower than the current flowing through the N-type MOSFET 2144 a sum of the compensations of the second and third differential pairs. Therefore, the current of the channel is decreased due to the reduction of the turning on period of the channel.

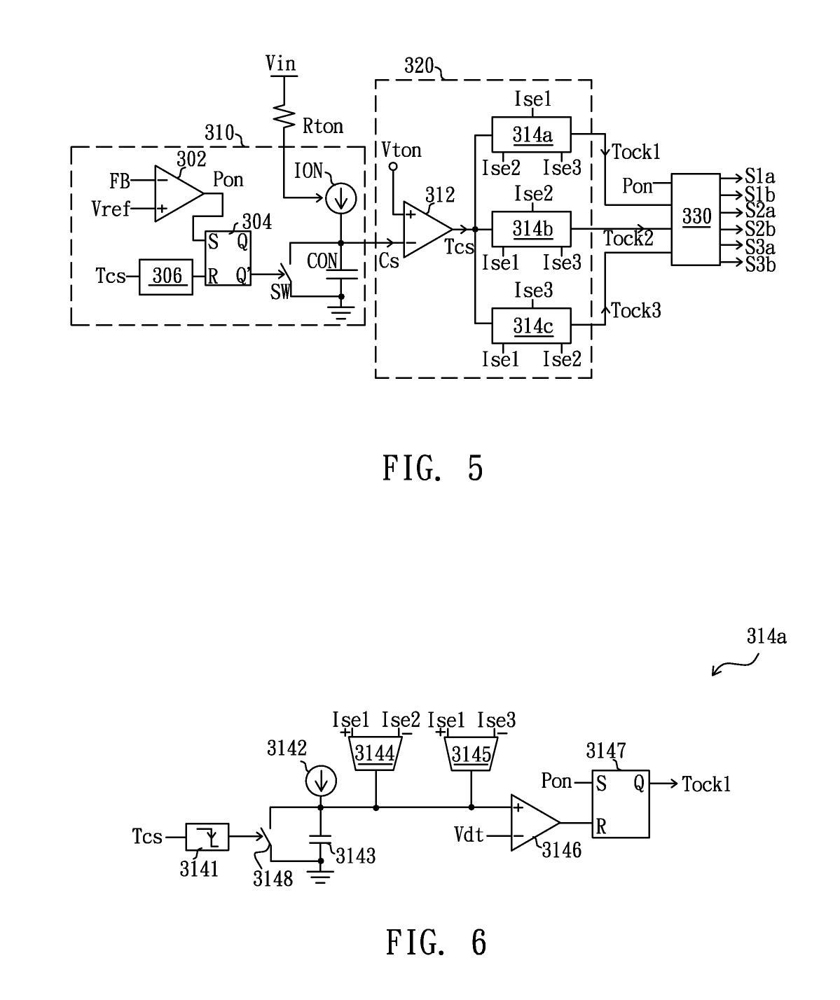

FIG. 5 is a schematic diagram of a multi-phase DC-DC converter according to a second embodiment of the present embodiment. The multi-phase DC-DC converter comprises a constant on unit 310, a PWM module 320 and a pulse width logic unit 330. The constant on unit 310 comprises a comparator 302, a SR flip-flop 304, a falling-edge detecting circuit 306, a current source ION, a switch SW and a time capacitor CON. A non-inverting input terminal of the comparator 302 receives a reference voltage Vref and an inverting input terminal thereof receives a voltage feedback signal FB. The comparator 302 outputs an output signal Pon to a set terminal S of the SR flip-flop 304 when the voltage level of the voltage feedback signal FB is lower than the voltage level of the reference voltage Vref. The falling-edge detecting circuit 306 is coupled to a reset terminal R of the SR flip-flop 304 and resets the SR flip-flop 304 when detecting a falling edge of a turning on determination signal Tcs. Therefore, the SR flip-flop 304 generates a signal at an inverting output terminal Q′ to control the switch SW according to the turning on determination signal Tcs and the output signal Pon. When the SR flip-flop 304 receives the output signal Pon, the SR flip-flop 304 turns the switch SW off and so the current source ION starts to charge the time capacitor CON to generate a turning on signal Cs. When the SR flip-flop 304 detects the falling edge of the turning on determination signal Tcs, the SR flip-flop 304 turns the switch SW on to reset the voltage of the time capacitor CON to be zero. The current source ION is connected to a time set resistance Rton externally to set an amount of the current of the current source ION for charging the time capacitor CON according to the time set resistance Rton. The time set resistance Rton is connected to the input voltage Vin in the present embodiment. Therefore, the constant on time period of the multi-phase DC-DC converter is adjusted to a proper value for different input voltage Vin.

The PWM module 320 comprises a comparator 312 and delay circuits 314a, 314b and 314c. A non-inverting input terminal of the comparator 312 receives a reference voltage Vton and an inverting input terminal thereof receives the turning on signal Cs. Accordingly, the comparator 312 generates the turning on determination signal Tcs. When the voltage level of the turning on signal Cs becomes higher than the voltage level of the reference voltage Vton, a level of the turning on determination signal Tcs becomes low form high. At this time, the falling-edge detecting circuit 306 resets the SR flip-flop 304. The delay circuits 314a, 314b and 314c detect the turning on determination signal Tcs and stop generating PMW signals Tock1, Tock2 and Tock3 in a delay time after detecting the turning on determination signal Tcs. The delay circuits 314a, 314b and 314c receive current detecting signals Ise1, Ise2 and Ise3 at the same time and adjust the delay time according to the current difference between the corresponding current detecting signal and other current detecting signals. The pulse width logic unit 330 is coupled to the PWM module 320, and generates PWM control signals S1a, S1b, S2a, S2b, S3a and S3b according to the PWM signals Tocl1, Tock2, Tock3 and the output signal Pon.

FIG. 6 is a schematic diagram of the PWM unit shown in FIG. 5. Due to the circuit structure of the PWM units 314a, 314b and 314c are the same; the PWM unit 314a is described for example here. The delay circuit 314a comprises a falling-edge detecting circuit 3141, a current source 3142, a capacitor 3143, delay adjustment elements 3144 and 3145, a comparator 3146, a SR flip-flop 3147 and a switch 3148. When the falling-edge detecting circuit 3141 detects a falling-edge of the turning on determination signal Tcs, the falling-edge detecting circuit 3141 generated a pulse signal to turn on the switch 3148 with a shorter period for resetting potential voltage of the capacitor 3143 to be zero. The current source 3142 is a constant current source for charging the capacitor 3143. A set terminal S of the SR flip-flop 3147 receives the output signal Pon to generate the PWM signal Tock1. A non-inverting terminal of the comparator 3146 is coupled to the capacitor 3143, an inverting terminal thereof receives a reference voltage Vdt and an output terminal thereof is coupled to a reset terminal R of the SR flip-flop 3147. The comparator 3146 outputs a high level signal to reset the SR flip-flop 3147 to stop generating the PWM signal. Tock1 when the voltage level of the capacitor 3143 is higher than the voltage level of the reference voltage Vdt. The current source 3142, the capacitor 3143, a comparator 3146 and a SR flip-flop 3147 constitute a base delay unit. If there are no the delay adjustment elements 3144 and 3145, a period for charging the capacitor 3143 to have a voltage equal to the reference voltage Vdt is a constant value and so the base delay unit determines a base delay time period. The delay adjustment elements 3144 and 3145 may be transimpedance amplifiers, in which non-inverting terminals thereof receive the current detecting signal Ise1 and inverting terminals thereof respectively receive the current detecting signal Ise2 and Ise3. When the current detecting signal Ise1 is higher than the current detecting signal Ise2 (Ise3), the delay adjustment element 3144 (3145) provides a current proportional to a level difference there between to additionally charge the capacitor 3143. Thereby, the period for charging the capacitor 3143 to have a voltage equal to the reference voltage Vdt is shortened. When the current detecting signal Ise1 is lower than the current detecting signal Ise2 (Ise3), the delay adjustment element 3144 (3145) provides a current proportional to a level difference there between to additionally discharge the capacitor 3143. Thereby, the period for charging the capacitor 3143 to have a voltage equal to the reference voltage Vdt is extended. The pulse widths of the PWM signals Tock1, Tock2 and Tock3 are determined by summing up a constant on time period of the constant on unit 310 determined by the time set resistance Rton and the respective delay time of the delay circuits 314a, 314b, 314c.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A multi-phase DC-DC converter, adapted to control a plurality of channels in a multi-phase DC-DC converting circuit for providing an output voltage, the multi-phase DC-DC converter comprising:
a constant on unit, determining a time point of generating a turning on signal indicative of a preset time period according to the output voltage;
a plurality of PWM units, each PWM unit generating a PWM signal, wherein a pulse width of the PWM signal is determined according to the turning on signal and currents of the channels; and
a pulse width logic unit, controlling the channels according to the corresponding PWM signals generated by the plurality of PWM units.

2. The multi-phase DC-DC converter according to claim 1, wherein each PWM unit adjusts the pulse width of the corresponding PWM signal to short a turning on period of the corresponding channel of the plurality of channels according to current differences between the corresponding channel and other channels.

3. The multi-phase DC-DC converter according to claim 2, wherein each PWM unit is a multi-input amplifier having a plurality of inputting end to receive the turning on signal and a plurality of current detecting signals indicative of currents flowing through the plurality of channels for generating the PWM signal.

4. The multi-phase DC-DC converter according to claim 3, wherein each multi-input amplifier comprises a plurality of differential pairs, in which each differential pair generates a differential signal according to the corresponding current detecting signal and one of the other current detecting signals and the PWM unit generates the PWM signal according to the differential signals.

5. The multi-phase DC-DC converter according to claim 2, wherein a plurality of PWM units comprises a plurality of delay circuits, in which each delay circuit determines the pulse width of the corresponding PWM signal according to the preset time period and a delay time that is determined according to the current differences between the corresponding channel and other channels.

6. The multi-phase DC-DC converter according to claim 5, in which each delay circuit comprising:
a base delay unit, determining a base delay time period;
at least one delay adjustment element, determining the delay time according to the base time period and the current differences between the corresponding channel and other channels; and
a pulse width delay generating element, determining the pulse width of the PWM signal according to a sum of the preset time period and the delay time.

7. A method of controlling a multi-phase DC-DC converter, adapted to balance currents of a plurality of channels in a multi-phase DC-DC converting circuit, comprising the steps of:
setting a constant on time period;
detecting the currents of the plurality of channels to generate a plurality of current detecting signals;
determining current differences between one channel and other channels; and
generating a PWM signal to control the corresponding channel, wherein a pulse width of the PWM signal is determined according the constant on time period and the current differences.

8. The method according to claim 7, wherein the constant on time period is set according to a resistance.

9. The method according to claim 8, wherein the current differences are determined by a multi-input amplifier according to a plurality of current detecting signals indicative of the plurality of channels.

10. The method according to claim 8, further comprising the steps:
determining a delay time according to the current differences by a delay circuit;
wherein the pulse width of the PWM signal is determined according to the constant on time period and the delay time.

11. The method according to claim 7, wherein the current differences are determined by a multi-input amplifier according to a plurality of current detecting signals indicative of the plurality of channels.

12. The method according to claim 7, further comprising the steps:
determining a delay time according to the current differences by a delay circuit;
wherein the pulse width of the PWM signal is determined according to the constant on time period and the delay time.
